(19) United States
(12) Patent Application Publication
(10) Pub. No.: US 2024/0399748 A1
(43) Pub. Date: Dec. 5, 2024

(54) INK JET RECORDING METHOD AND INK JET RECORDING APPARATUS

(71) Applicant: CANON KABUSHIKI KAISHA, Tokyo (JP)

(72) Inventors: SOICHI NAGAI, Kanagawa (JP); YUKO NISHIWAKI, Tokyo (JP); ATSUHITO YOSHIZAWA, Tokyo (JP); ERIKO YOSHINO, Kanagawa (JP)

(21) Appl. No.: 18/670,889

(22) Filed: May 22, 2024

(30) Foreign Application Priority Data
Jun. 5, 2023 (JP) 2023-092622
Apr. 25, 2024 (JP) 2024-071535

(51) Int. Cl. B41J 2/165; B41J 2/175; C09D 11/033; C09D 11/037; C09D 11/102; C09D 11/322

(52) U.S. Cl. CPC B41J 2/16535; B41J 2/175; C09D 11/033; C09D 11/037; C09D 11/102; C09D 11/322; B41P 2235/21

(57) ABSTRACT

Provided is an ink jet recording method by which an image excellent in water resistance and scratch resistance can be recorded while the occurrence of ejection misdirection immediately after the start of initial use is suppressed. The method is an ink jet recording method including recording an image with an ink jet recording apparatus including: an aqueous ink containing an organic pigment and a resin; an ink storage portion configured to store the aqueous ink; a recording head incorporated into the ink storage portion, the recording head having an ejection orifice surface having formed storage portion; and a wiping unit configured to wipe the ejection orifice surface, the recording being performed by applying the aqueous ink ejected from the ejection orifice to a recording medium.

### BACKGROUND OF THE INVENTION

### Field of the Invention

The present invention relates to an ink jet recording method and an ink jet recording apparatus.

### Description of the Related Art

According to an ink jet recording method, images can be recorded on various recording mediums. In recent years, an ink jet recording apparatus mounted with an ink cartridge having such a configuration that a recording head is incorporated into an ink storage portion storing an aqueous ink has become widespread for the purposes of: simplifying and downsizing an apparatus configuration; and shortening preparation by the time of recording at the time of initial use. In addition, in a business field, the ink jet recording method has been utilized at the time of the recording of a document including a text and a color chart or the like on a recording medium such as plain paper. In such applications, a need for an ink containing a resin has been growing more and more because the ink hardly causes image distortion due to ejection misdirection and can record an image excellent in water resistance and scratch resistance.

To suppress the occurrence of the ejection misdirection that is one cause for the occurrence of the image distortion, an approach in which a washing unit using a washing liquid is adopted has been known. In addition, there has been proposed an ink jet recording apparatus including a sheet-shaped wiping member having a void with which an ink sticking to an ejection orifice surface can be efficiently removed (Japanese Patent Application Laid-Open No. 2020-128031).

### SUMMARY OF THE INVENTION

The inventors of the present invention have prepared an ink jet recording apparatus including: an ink cartridge having incorporated thereinto a recording head; and a unit that wipes the ejection orifice surface of the recording head. Then, the inventors have investigated the recording of an image by the ejection of an aqueous ink containing an organic pigment and a resin from the recording head of the ink jet recording apparatus. As a result, the inventors have revealed that ejection misdirection is liable to occur immediately after the start of the initial use of the apparatus. Ejection misdirection has heretofore occurred after the ejection of a certain amount of the ink or in such a case that the apparatus is used again after its nonuse period. Accordingly, the ejection misdirection immediately after the start of the initial use is a problem caused by a factor different from that of the conventional ejection misdirection. In addition, the inventors have found that when a dye ink or an ink free of any resin is used, no ejection misdirection occurs immediately after the start of the initial use.

Further, the inventors have found that when the aqueous ink containing the organic pigment and the resin is ejected from the recording head that is not integrated with the ink storage portion, no ejection misdirection occurs immediately after the start of the initial use. That is, the inventors have revealed that the ejection misdirection occurring immediately after the start of the initial use is a problem occurring when the aqueous ink containing the organic pigment and the resin is ejected from the recording head of the ink cartridge having incorporated thereinto the recording head to record an image.

Accordingly, an object of the present invention is to provide an ink jet recording method by which an image excellent in water resistance and scratch resistance can be recorded while the occurrence of ejection misdirection immediately after the start of initial use is suppressed. In addition, another object of the present invention is to provide an ink jet recording apparatus to be used in the ink jet recording method.

That is, according to the present invention, there is provided an ink jet recording method comprising recording an image with an ink jet recording apparatus comprising: an aqueous ink comprising an organic pigment and a resin; an ink storage portion configured to store the aqueous ink; a recording head incorporated into the ink storage portion, the recording head comprising an ejection orifice surface having formed therein an ejection orifice configured to eject the aqueous ink supplied from the ink storage portion; and a wiping unit configured to wipe the ejection orifice surface, the recording being performed by applying the aqueous ink ejected from the ejection orifice to a recording medium, wherein the ejection orifice surface of the recording head has bonded thereto a protective tape comprising an adhesive layer formed from an adhesive, the protective tape being peeled at a time of use thereof, and wherein a direction in which the protective tape is peeled and a direction in which the ejection orifice surface is wiped with the wiping unit intersect each other or are opposite directions.

Further features of the present invention will become apparent from the following description of exemplary embodiments with reference to the attached drawings.

### BRIEF DESCRIPTION OF THE DRAWINGS

FIG. 1A is a perspective view for schematically illustrating an ink jet recording apparatus according to one embodiment of the present invention.

FIG. 1B is a view for schematically illustrating the ink jet recording apparatus according to one embodiment of the present invention, and is a perspective view of a state in which a cover member is opened.

FIG. 2 is a perspective view for schematically illustrating the internal structure of the ink jet recording apparatus according to one embodiment of the present invention.

FIG. 3 is a perspective view for schematically illustrating an example of a recording unit.

FIG. 4A is a perspective view for schematically illustrating an example of the recording unit.

FIG. 4B is a view for schematically illustrating an example of the recording unit, and is a perspective view of an exploded state.

### DESCRIPTION OF THE EMBODIMENTS

The present invention is described in more detail below by way of exemplary embodiments. In the present invention, when a compound is a salt, the salt is present as dissociated ions in an ink, but the expression “contain a salt” is used for convenience. In addition, an aqueous ink for ink jet is sometimes simply referred to as “ink”. Physical property values are values at normal temperature (25° C.) unless otherwise stated. In this specification, with regard to the direction in which a protective tape is peeled, the direction in which an ejection orifice surface is wiped and the direction in which an ejection orifice array is arrayed, a state in which those directions are “substantially parallel”, “directions substantially identical” or “directions substantially opposite” to each other may be referred to as “parallel”, “identical direction” or “opposite directions” by omitting the term “substantially”.

The inventors of the present invention have prepared an ink cartridge in which a recording head having an ejection orifice surface having formed therein an ejection orifice that ejects an ink is incorporated into an ink storage portion. Then, the inventors have used the prepared ink cartridge and have analyzed ejection misdirection occurring when an ink containing an organic pigment and a resin is ejected from the recording head immediately after its unsealing by the peeling of its protective tape. The ink cartridge in which the ink storage portion and the recording head are integrally formed is typically stored under a state in which a protective tape including an adhesive layer is bonded to the ejection orifice surface of the recording head to close the ejection orifice for suppressing the evaporation of the ink. Then, at the time of the first use (at the time of the start of the initial use), the ink cartridge packed in a closed container is unsealed and the protective tape is peeled. After that, the cartridge is mounted on a recording apparatus to start image recording. However, the inventors have found that when the protective tape is peeled, part of the adhesive for forming the adhesive layer may remain under the state of adhering to the ejection orifice surface and the ejection misdirection of the ink occurs owing to the remaining adhesive.

However, the inventors have found that when a dye ink or an organic pigment ink free of any resin is used, no ejection misdirection occurs even under a state in which the adhesive adheres to the ejection orifice surface of the recording head. The inventors have observed the ejection orifice surface of the recording head undergoing the ejection misdirection of the ink from which the bonded protective tape has been peeled. As a result, the adhesion residue of the adhesive was observed. In addition, the inventors have measured the contact angles of the ejection orifice surface with various inks before the bonding of the protective tape, and the contact angles of the ejection orifice surface with the various inks after the bonding and peeling of the protective tape. As a result, the inventors have found that the contact angles thereof with an ink containing a resin before and after the bonding of the protective tape largely differ from each other in a peculiar manner. That is, it is conceivable that the ejection orifice surface in a state in which the adhesive adheres thereto facilitates the wetting of the ink containing the resin to cause its ejection misdirection.

When a recording unit of such a type that an ink storage portion is set in a head cartridge including a recording head is used, the suppression of the evaporation of an ink from an ejection orifice, which is required in an ink cartridge in which the recording head is incorporated into the ink storage portion, is not required. Accordingly, when the recording unit of such a type that the ink storage portion is set in the head cartridge including the recording head is used, the ejection misdirection of the ink resulting from the remaining adhesive does not occur.

The inventors of the present invention have observed the state of the ejection orifice surface while the direction in which the protective tape is peeled and the direction in which the ejection orifice surface is wiped with a wiping unit are made the same direction. As a result, the inventors have found that unlike the case where the directions are made to intersect each other or to be opposite directions, the removal of the remaining adhesive becomes insufficient to make it difficult to suppress the occurrence of the ejection misdirection of the ink. Further, the inventors of the present invention have investigated a material for a wiper that is one wiping unit and the composition of a washing liquid to be used in the wiping. For example, when a sheet-shaped wiping member having a void was used, the efficiency with which the remaining adhesive was removed improved to enable the suppression of the occurrence of the ejection misdirection of the ink immediately after the start of the initial use of the recording apparatus. However, the inventors have found that the deterioration of the ejection orifice surface such as the shaving of a water-repellent material for forming the ejection orifice surface is liable to occur, and hence the ejection misdirection of the ink is liable to occur owing to the long-term use of the apparatus. In addition, the inventors have found that wiping with a washing liquid containing a large amount of a “good solvent” such as a solvent having a satisfactory moisture-retaining property, which can improve the re-solubility of the ink, exhibits a weak removing effect on the remaining adhesive. In addition, the inventors have found that wiping with a washing liquid containing a large amount of a “poor solvent” such as a solvent having satisfactory solubility for a substance improves the efficiency with which the remaining adhesive is removed, but the wiping facilitates the aggregation of the ink and hence the non-ejection or ejection misdirection of the ink is liable to occur in some cases.

The inventors of the present invention have further investigated the conditions under which the ejection orifice surface is wiped and the composition of the ink. As a result, the inventors have found that the following configuration enables the recording of an image excellent in water resistance and scratch resistance, the properties being required in a business document or the like, while suppressing the occurrence of ejection misdirection immediately after the start of the initial use.

That is, in an ink jet recording method of the present invention, there is used an ink jet recording apparatus including: an ink containing an organic pigment and a resin; an ink storage portion configured to store the ink; and a recording head incorporated into the ink storage portion. The recording head has an ejection orifice surface having formed therein an ejection orifice configured to eject the ink supplied from the ink storage portion. The ink jet recording apparatus further includes a wiping unit configured to wipe the ejection orifice surface. A protective tape including an adhesive layer formed from an adhesive is bonded to the ejection orifice surface of the recording head for suppressing the evaporation of the ink from the ejection orifice, and the protective tape is peeled at the time of the first use of the ink jet recording apparatus. In addition, the direction in which the protective tape is peeled and the direction in which the ejection orifice surface is wiped with the wiping unit intersect each other or are opposite directions.

When the protective tape is peeled from the ejection orifice surface of the recording head, part of the adhesive for forming the adhesive layer of the protective tape remains under a “fuzzy state” on the ejection orifice surface. It is conceivable from the foregoing that when the direction in which the protective tape is peeled and the direction in which the ejection orifice surface is wiped with the wiping unit are made to intersect each other or to be opposite directions, the adhesive remaining under a fuzzy state can be efficiently removed. Thus, the occurrence of the ejection misdirection of the ink immediately after the start of the initial use of the apparatus can be suppressed.

### <Ink Jet Recording Method and Ink Jet Recording Apparatus>

The ink jet recording method of the present invention is a recording method including using an ink jet recording apparatus including: an ink; an ink storage portion configured to store the ink; a recording head; and a wiping unit configured to wipe the ejection orifice surface of the recording head. The ink contains an organic pigment and a resin. The recording head is a recording head incorporated into the ink storage portion, the recording head having the ejection orifice surface having formed therein an ejection orifice configured to eject the ink supplied from the ink storage portion. The ink jet recording method of the present invention includes a step of recording an image by applying the ink ejected from the ejection orifice of the recording head to a recording medium. A protective tape including an adhesive layer formed from an adhesive, the protective tape being peeled at the time of the use of the apparatus, is bonded to the ejection orifice surface of the recording head. In addition, the direction in which the protective tape is peeled and the direction in which the ejection orifice surface is wiped with the wiping unit intersect each other or are opposite directions.

In addition, an ink jet recording apparatus of the present invention includes: an ink; an ink storage portion configured to store the ink; a recording head; and a wiping unit configured to wipe the ejection orifice surface of the recording head. The ink contains an organic pigment and a resin. The recording head is a recording head incorporated into the ink storage portion, the recording head having the ejection orifice surface having formed therein an ejection orifice configured to eject the ink supplied from the ink storage portion. A protective tape including an adhesive layer formed from an adhesive, the protective tape being peeled at the time of the use of the apparatus, is bonded to the ejection orifice surface of the recording head. In addition, the direction in which the protective tape is peeled and the direction in which the ejection orifice surface is wiped with the wiping unit intersect each other or are opposite directions.

### (Ink Jet Recording Apparatus)

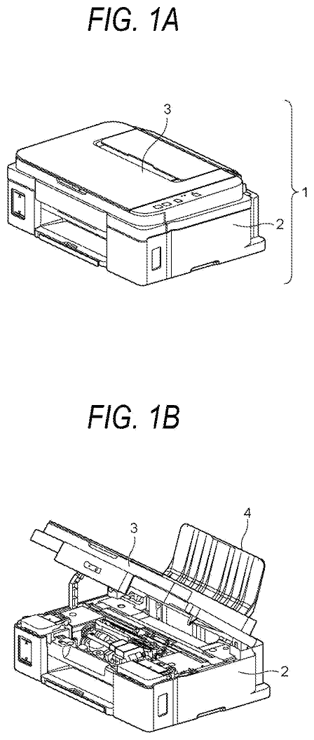

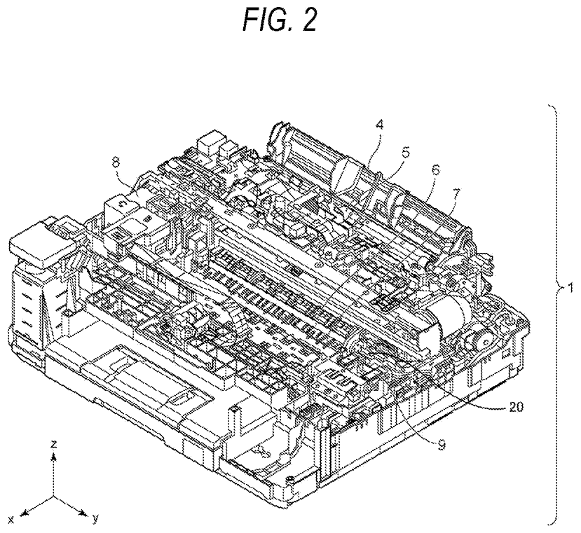

FIG. 1A and FIG. 1B are each a view for schematically illustrating an ink jet recording apparatus according to one embodiment of the present invention. FIG. 1A is a perspective view and FIG. 1B is a perspective view of a state in which a cover member is opened. As illustrated in each of FIG. 1A and FIG. 1B, an ink jet recording apparatus 1 of this embodiment includes an outer package 2 and a cover member 3 arranged on the upper surface of the outer package 2. The cover member 3 is a member that is openable and closable in a vertical direction, and its opening in an upper direction enables the observation of the inside of the ink jet recording apparatus 1. The ink jet recording apparatus 1 has a substantially rectangular parallelepiped shape and includes a sheet-feeding tray 4 in its rear. FIG. 1B is an illustration of a state in which the sheet-feeding tray 4 is extended from the outer package 2. Although FIG. 1A, FIG. 1B and FIG. 2 are each an illustration of an apparatus mounted with one color ink for simplicity, the kinds of inks and the number of the inks are not limited to those illustrated in each of FIG. 1A, FIG. 1B and FIG. 2.

FIG. 2 is a perspective view for schematically illustrating the internal structure of the ink jet recording apparatus according to one embodiment of the present invention. The ink jet recording apparatus 1 of the embodiment illustrated in FIG. 2 includes the sheet-feeding tray 4 on the rear side of its outer package. A recording medium such as paper is arranged in the sheet-feeding tray 4. A recording unit 8 is arranged in the ink jet recording apparatus 1. A recording head is arranged in the lower portion of the recording unit 8. The recording unit 8 ejects the ink from an ejection orifice of the recording head while reciprocating in a y-direction in FIG. 2. The recording medium arranged in the sheet-feeding tray 4 is fed forward in an x-direction by a sheet-feeding roller 5 and a conveying roller 6, and reaches a platen 7 where the medium is supported. The recording medium supported by the platen 7 is arranged at a position facing the recording head and under the state, the ink is ejected from the recording head to the recording medium. The ejected ink adheres to the recording medium to record an image on the recording medium. In the ink jet recording apparatus 1, a cap 9, which is brought into abutment with a region including the ejection orifice surface of the recording head and covers the ejection orifice, is further arranged at a home position. The ejection orifice surface of the recording head 1 is wiped by a wiper 20 under a state in which the recording unit 8 is at its home position.

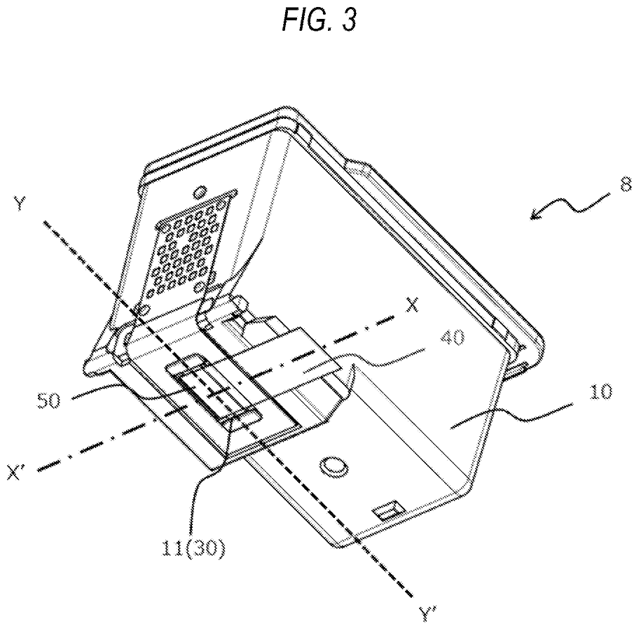

FIG. 3 is a perspective view for schematically illustrating an example of the recording unit (ink cartridge). As illustrated in FIG. 3, the recording unit 8 includes: an ink storage portion 10 that is a casing formed from a material such as a thermoplastic resin; and a recording head 11 incorporated into the ink storage portion 10. In other words, the recording head 11 is formed integrally with the ink storage portion 10. An ink containing an organic pigment and a resin is stored in the ink storage portion 10. The recording head 11 has an ejection orifice surface 30 having formed therein an ejection orifice that ejects the ink supplied from the ink storage portion 10. A protective tape 50 including an adhesive layer formed from an adhesive, the protective tape being peeled at the time of the initial use of the ink cartridge, is bonded to the ejection orifice surface 30 of the recording head 11. The direction in which the protective tape 50 is peeled may be regulated, for example, as described below. A tab 40 serving as a nonbonded portion that is not bonded to the recording head is arranged in an end portion of the protective tape along the peeling direction. With such configuration, it becomes easier to peel the protective tape in its lengthwise direction from the tab 40 and hence the peeling direction can be regulated. To regulate the peeling direction more simply and more reliably, it is preferred that no nonbonded portion be arranged in a direction intersecting the peeling direction. In addition, the direction in which the protective tape 50 is peeled is preferably a direction intersecting the direction in which the ejection orifice array of the recording head 11 is arrayed. In particular, it is more preferred that as illustrated in FIG. 3, the direction in which the protective tape 50 is peeled be set to an X-X′ direction and the direction in which the ejection orifice array of the recording head 11 is arrayed be set to a Y-Y′ direction. The configuration and peeling direction of the protective tape are not limited to those illustrated in FIG. 3.

Examples of the ink ejection system of the recording head include: a system including applying mechanical energy generated by a piezo element or the like to the ink to eject the ink; and a system including applying thermal energy generated by an electro-thermal converter (heater) or the like to the ink to eject the ink. Each of the ink ejection systems may be adopted.

The protective tape is a member to be used for suppressing the evaporation of a component that may evaporate in the ink such as water from the ejection orifice of the recording head. The protective tape includes the adhesive layer formed from the adhesive. Examples of the adhesive may include an acrylic adhesive, a silicone-based adhesive and ethylene vinyl acetate (EVA). Of those, an acrylic adhesive and a silicone-based adhesive are preferred, and a silicone-based adhesive is more preferred. In the case where the silicone-based adhesive is used, as compared to the case where any other adhesive such as an acrylic adhesive is used, the deterioration of the adhesive due to the ink hardly occurs even at a pH (alkaline) that an aqueous ink for ink jet generally has. Accordingly, the adhesion residue of the adhesive hardly occurs and hence the occurrence of the ejection misdirection of the ink is easily suppressed. The adhesive layer is formed on, for example, the surface of a sheet-shaped or film-shaped base material. A resin material such as polyethylene terephthalate (PET) may be used as the base material.

The ink jet recording apparatus includes the wiping unit that wipes the ejection orifice surface of the recording head. In addition, as described above, the direction in which the protective tape is peeled and the direction in which the ejection orifice surface is wiped with the wiping unit intersect each other or are opposite directions. When the peeling direction and the wiping direction intersect each other, an angle formed by the directions may be set to an arbitrary angle except 0°. In particular, it is preferred that the peeling direction and the wiping direction be substantially perpendicular to each other. When the peeling direction and the wiping direction are opposite directions, the angle formed by the directions is substantially 0°. It is particularly preferred that the direction in which the protective tape is peeled and the direction in which the ejection orifice surface is wiped with the wiping unit be directions intersecting each other. In addition, it is particularly preferred that the direction in which the ejection orifice surface is wiped with the wiping unit and the direction in which the ejection orifice array of the recording head is arrayed be substantially parallel to each other, and those directions intersect the direction in which the protective tape is peeled. For example, a wiper that can slide while being brought into abutment with the ejection orifice surface may be used as the wiping unit. The shape of the wiper is preferably a blade shape. The use of the blade-shaped wiper can further improve the property by which the ejection orifice surface is wiped. A material having rubber elasticity is preferred as a material for forming the wiper. The material for forming the wiper may be, for example, a rubber material (urethane rubber) formed from a urethane resin.

The thickness of the wiper is preferably 0.4 mm or more to 1.1 mm or less. When the thickness of the wiper is less than 0.4 mm, the efficiency with which the adhesive adhering to the ejection orifice surface is removed may reduce to some extent. Meanwhile, when the thickness of the wiper is more than 1.1 mm, the ejection orifice surface of the recording head may be liable to be flawed and hence the ejection misdirection may be somewhat liable to occur owing to the long-term use of the recording apparatus.

The moving speed of the wiper at the time of the wiping is preferably 15 mm/s or more to 130 mm/s or less. When the moving speed of the wiper is less than 15 mm/s, the ejection orifice surface of the recording head may be liable to be flawed and hence the ejection misdirection may be somewhat liable to occur owing to the long-term use. Meanwhile, when the moving speed of the wiper is more than 130 mm/s, the efficiency with which the adhesive adhering to the ejection orifice surface is removed may reduce to some extent.

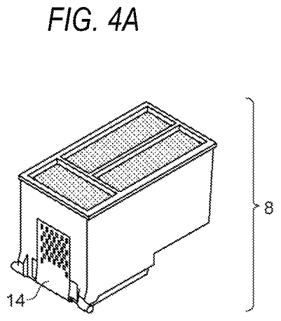

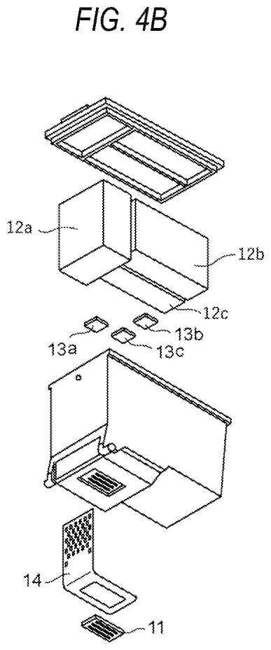

FIG. 4A and FIG. 4B are each a view for schematically illustrating an example of the recording unit. FIG. 4A is a perspective view and FIG. 4B is a perspective view of an exploded state. The recording unit 8 illustrated in each of FIG. 4A and FIG. 4B includes: the ink storage portion 10 that is a casing; and the recording head 11. The recording head 11 is bonded to the ink storage portion 10 without through intermediation of any other member. The ink storage portion 10 has a light weight because the portion is a casing formed from a material such as a thermoplastic resin. Further, the entirety of the recording unit 8 is reduced in size and weight because the recording head 11 is bonded to the ink storage portion 10 without through intermediation of any other member such as a heat-radiating plate. The use of such recording unit 8 can reduce the size and weight of the entirety of the ink jet recording apparatus. The heat-radiating plate may be, for example, a plate formed from a material such as a metal oxide such as alumina. Although there is no need to interpose any other member such as a heat-radiating plate between the ink storage portion 10 and the recording head 11, an adhesion layer formed from an adhesive or the like, the layer being intended to fix the recording head 11 to the ink storage portion 10, may be present.

The recording head 11 has arranged therein, for example, a plurality of ejection orifices that eject the ink and an energy-generating element that generates thermal energy for ejecting the ink. The energy-generating element and the like may be driven by, for example, electric power supplied through an electrical wiring member 14. The energy-generating element is an element that generates thermal energy and the action of the generated thermal energy can eject the ink from the ejection orifices.

The recording head 11 has such an ejection orifice surface that an ejection orifice array including the plurality of ejection orifices is arrayed in one and the same recording element substrate. The ejection orifice array is preferably arrayed in a direction (sub-scanning direction) substantially perpendicular to the reciprocating direction (main scanning direction) of the recording unit. A plurality of ejection orifice arrays may be arrayed in the recording element substrate. In this case, one recording unit can eject a plurality of inks and hence the entirety of the ink jet recording apparatus can be downsized. Sponge-like ink absorbers 12a to 12c are stored in the ink storage portion 10. In addition, filters 13a to 13c are arranged below the ink storage portion 10 in a gravity direction. When a negative pressure is generated by utilizing the capillary forces of the sponge-like ink absorbers 12a to 12c, the ink can be prevented from leaking from the ejection orifices. In addition, the arrangement of the filters 13a to 13c can prevent the entry of fine foreign matter such as dirt into the ejection orifices.

The recording head preferably includes a warming unit configured to warm the ink in the recording head. The warming unit only needs to be a unit that can warm the ink in the recording head to a temperature equal to or more than the clouding point of a surfactant in the ink. Examples of such warming unit may include: a heater for ink temperature control arranged so as to be brought into contact with the recording head; and a heater for ink ejection. To warm the ink with the heater for ink ejection, for example, such a current that the ink is not ejected only needs to be repeatedly passed through the heater. The ink in the recording head is preferably warmed to a temperature of 40° C. or more to 70° C. or less.

A material for the ejection orifice surface of the recording element substrate for forming the recording head 11 may be, for example, a resin material such as an epoxy resin. A recording head in which an ejection orifice surface formed from a resin material is subjected to water-repellent treatment is preferably used because a reduction in ejection characteristic due to the ink adhering to the ejection orifice surface is easily suppressed. In particular, it becomes easier to peel the protective tape and its adhesive more hardly remains on the ejection orifice surface. In addition, it becomes easier to remove the adhesive remaining on the ejection orifice surface through wiping.

The ejection orifice surface of the recording head is preferably subjected to water-repellent treatment. A method for subjecting the ejection orifice surface to the water-repellent treatment may be, for example, a method including applying a water-repellent material to the surface with a spray or the like or a method including causing the water-repellent material to adhere to the surface through vacuum deposition or plasma polymerization. The water repellency of the ejection orifice surface may be evaluated by measuring the contact angle thereof with water. When the contact angle with the water is 70° or more, the surface can be judged to be “water-repellent.” The contact angle with the water is preferably 90° or more. The contact angle with the water may be measured by using pure water (ion-exchanged water) and a general contact angle meter. The contact angle meter may be, for example, an automatic contact angle-measuring machine (product name: “CA-W”, manufactured by Kyowa Interface Science Co., Ltd.).

The water-repellent material for subjecting the ejection orifice surface to the water-repellent treatment may be, for example, a compound of a fluorine-based resin. A water-repellent surface is preferably formed as a uniform resin film formed from such material, and the resin film is preferably free of a metal such as nickel. Examples of the fluorine-based resin may include a polytetrafluoroethylene resin and a fluorine resin having a cyclic structure. The examples may also include other resins each having a fluorine atom, such as a fluorinated epoxy resin, a fluorinated polyimide resin, a fluorinated polyamide resin, a fluorinated acrylic resin, a fluorinated urethane resin, a fluorinated siloxane resin and modified resins thereof. In addition, a silicon atom-containing compound or a silicone-based resin may be used as the water-repellent material. Of those, a condensate of a hydrolyzable silane compound having a fluoroalkyl group and a hydrolyzable silane compound having a cationically polymerizable group is preferably used because a high degree of water repellency is obtained. The material may also be, for example, a silicone-based resin obtained by applying an active energy ray such as UV light to the condensate to cure the condensate. The hydrolyzable silane compounds each have a hydrolyzable group such as an alkoxy group in its molecular structure. In addition, examples of the cationically polymerizable group may include a cyclic ether group and a cyclic vinyl ether group.

### (Aqueous Ink)

In the ink jet recording method of the present invention, an ink containing an organic pigment and a resin is used. The method includes a step of recording an image by applying the ink ejected from an ejection orifice to a recording medium. A component for forming the ink and the like are described below.

### [Coloring Material]

The organic pigment (hereinafter sometimes simply referred to as “pigment”) is used as a coloring material for the ink. Examples of the pigment may include an azo pigment, a phthalocyanine pigment, a quinacridone pigment, an isoindolinone pigment, an imidazolone pigment, a diketopyrrolopyrrole pigment, a dioxazine pigment and a perionone pigment.

The content (% by mass) of the organic pigment in the aqueous ink is preferably 0.5% by mass or more to 10.0% by mass or less, more preferably 1.0% by mass or more to 8.0% by mass or less with respect to the total mass of the ink.

Examples of a dispersion system for the pigment may include a resin-dispersed pigment using a resin (resin dispersant) as a dispersant and a self-dispersible pigment having a hydrophilic group bonded to its particle surface. In addition, a resin-bonded pigment having a resin-containing organic group chemically bonded to its particle surface, a microcapsule pigment whose particle surface is covered with, for example, a resin, or the like may be used.

A dispersant that can disperse the pigment in an aqueous medium through the action of an anionic group is preferably used as a resin dispersant for dispersing the pigment in the aqueous medium. A resin to be described later, in particular, a water-soluble resin may be used as the resin dispersant. The mass ratio of the content (% by mass) of the resin dispersant in the aqueous ink to the content (% by mass) of the organic pigment therein is preferably 0.1 times or more to 0.6 times or less. When the above-mentioned mass ratio is more than 0.6 times, the scratch resistance of the image tends to be improved but the ejection misdirection of the ink tends to be liable to occur immediately after the start of the initial use of the ink jet recording apparatus.

A pigment having an anionic group, such as a carboxylic acid group, a sulfonic acid group or a phosphonic acid group, bonded to its particle surface directly or through any other atomic group (—R—) may be used as the self-dispersible pigment. The anionic group may be any one of an acid type or a salt type. When the group is a salt type, the group may be in any one of a state in which part of the group dissociates or a state in which the entirety thereof dissociates. When the anionic group is a salt type, examples of a cation serving as a counterion may include an alkali metal cation, ammonium and an organic ammonium. Specific examples of the other atomic group (—R—) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, groups obtained by combining those groups may be adopted.

### [Resin]

The ink contains a resin. The content (% by mass) of the resin in the aqueous ink is preferably 0.1% by mass or more to 20.0% by mass or less, more preferably 0.5% by mass or more to 15.0% by mass or less with respect to the total mass of the ink. The mass ratio of the content (% by mass) of the resin in the aqueous ink to the content (% by mass) of the organic pigment therein is preferably 0.1 times or more to 1.0 times or less, more preferably 0.1 times or more to 0.6 times or less. The content of the resin is a value including a dispersant for dispersing the pigment.

The resin may be added to the ink (i) for stabilizing the dispersed state of the pigment, that is, as a resin dispersant or an aid therefor. In addition, the resin may be added to the ink (ii) for improving the various characteristics of an image to be recorded. Examples of the form of the resin may include a block copolymer, a random copolymer, a graft copolymer and a combination thereof. In addition, the resin may be a water-soluble resin that can be dissolved in an aqueous medium or may be a resin particle to be dispersed in the aqueous medium. Of those, a water-soluble resin is preferred and the water-soluble resin is preferably a resin dispersant for dispersing the pigment.

Examples of the resin may include an acrylic resin, a polyester resin, a urethane resin, a urea resin, polysaccharides and polypeptides. Of those, an acrylic resin is preferred from the viewpoint of its ejection characteristic from the ejection orifice of the recording head. A resin including, as constituent units, a unit having an anionic group and a unit free of any anionic group is preferred as the acrylic resin. The acrylic resin is a resin including at least a unit derived from an acrylic monomer, such as (meth)acrylic acid or a (meth)acrylate. Examples of the form of the acrylic resin may include a random copolymer, a block copolymer, a graft copolymer and combinations thereof.

Examples of a monomer to be turned into a unit for forming the acrylic resin by its polymerization may include a monomer having an anionic group and a monomer free of any anionic group. In normal cases, the monomer having an anionic group is turned into a hydrophilic unit by its polymerization and the monomer free of any anionic group is turned into a hydrophobic unit by its polymerization.

Examples of the monomer having an anionic group may include: monomers each having a carboxylic acid group, such as (meth)acrylic acid, itaconic acid, maleic acid and fumaric acid; and anhydrides and salts of those monomers. Examples of a cation for forming a salt of the monomer having an anionic group may include a lithium cation, a sodium cation, a potassium cation, an ammonium cation and an organic ammonium cation.

Examples of the monomer free of any anionic group may include: monomers each having an aromatic group, such as styrene, α-methylstyrene, benzyl (meth)acrylate, 2-vinylpyridine, 4-vinylpyridine and 1-vinylimidazole; and (meth)acrylic acid esters, such as ethyl (meth)acrylate, methyl (meth)acrylate, (iso)propyl (meth)acrylate, (n-, iso-, t-)butyl (meth)acrylate and 2-ethylhexyl (meth)acrylate.

Of those, an acrylic resin including a hydrophilic unit derived from (meth)acrylic acid and a hydrophobic unit derived from at least one of a monomer having an aromatic ring or a (meth)acrylic acid ester-based monomer is preferred. In particular, an acrylic resin including a hydrophilic unit derived from (meth)acrylic acid and a hydrophobic unit derived from at least one of a styrene monomer or an α-methylstyrene monomer is preferred. Those acrylic resins are each suitable as a resin dispersant for dispersing the pigment in an aqueous medium because the resins each easily interact with the pigment.

The urethane resin may be obtained by, for example, causing a polyisocyanate and a polyol to react with each other. In addition, a chain extender may be further caused to react with the reaction product. Examples of the olefin resin may include polyethylene and polypropylene.

### [Aqueous Medium]

The ink is an aqueous ink containing at least water as an aqueous medium. The water or an aqueous medium that is a mixed solvent of the water and a water-soluble organic solvent may be incorporated into the ink. The ink preferably contains the water-soluble organic solvent. Deionized water or ion-exchanged water is preferably used as the water. The content (% by mass) of the water in the ink is preferably 50.0% by mass or more to 95.0% by mass or less with respect to the total mass of the ink. Solvents that may be used in inks for ink jet, such as alcohols, glycols, glycol ethers and nitrogen-containing compounds, may each be used as the water-soluble organic solvent. The content (% by mass) of the water-soluble organic solvent in the ink is preferably 3.0% by mass or more to 50.0% by mass or less, more preferably 15.0% by mass or more to 30.0% by mass or less with respect to the total mass of the ink.

The ink preferably contains at least one kind of water-soluble organic solvent selected from the group consisting of: a compound having a cyclic amide structure; an alkanediol; and an amine compound. The ink more preferably contains at least two kinds of water-soluble organic solvents selected therefrom. The use of an ink containing such water-soluble organic solvent can further suppress ejection misdirection immediately after the start of the initial use of the ink jet recording apparatus. The compound having a cyclic amide structure may be, for example, 1-(2-hydroxyethyl)-2-pyrrolidone. The alkanediol is a compound, which is obtained by substituting a saturated hydrocarbon chain having about 2 to 8 carbon atoms with two hydroxy groups, and examples thereof may include 1,2-hexanediol, 1,5-pentanediol and 1,6-hexanediol. The amine compound may be, for example, triethanolamine.

### [Surfactant]

The ink preferably further contains a surfactant. In addition, the ink particularly preferably contains a surfactant having a clouding point. In addition, the ink jet recording method of the present invention preferably further includes a step of warming the ink in the recording head to the clouding point of the surfactant or more with the warming unit, followed by the wiping of the ejection orifice surface with the wiping unit. Thus, so-called “clouding point washing” can be performed and hence the efficiency with which the adhesive adhering to the ejection orifice surface is removed can be further improved. Accordingly, the ejection misdirection immediately after the start of the initial use can be further suppressed. The clouding point of the surfactant refers to the temperature at which when an aqueous solution of a nonionic surfactant is heated, the solute (nonionic surfactant) and water start to separate from each other to cloud the aqueous solution, and the clouding point is specified as 1047 in JIS K 3211:1990. In Examples to be described later, the temperature at which a 1.0% by mass aqueous solution of a surfactant started to cloud when heated was measured.

Examples of the surfactant may include an anionic surfactant, a cationic surfactant and a nonionic surfactant. Of those, nonionic surfactants, such as an acetylene glycol-based surfactant and a polyoxyethylene alkyl ether, are preferably used. The content (% by mass) of the surfactant in the ink is preferably 0.1% by mass or more to 5.0% by mass or less, more preferably 0.1% by mass or more to 2.0% by mass or less with respect to the total mass of the ink. In particular, the content is particularly preferably 0.1% by mass or more to 1.0% by mass or less.

### [Other Components]

Further, as required, the ink may contain various additives, such as an antifoam agent, a pH adjuster, a viscosity adjuster, a rust preventive, a preservative, a fungicide, an antioxidant and a reduction inhibitor.

### [Physical Properties of Ink]

The ink is an aqueous ink to be applied to an ink jet system. Accordingly, from the viewpoint of reliability, it is preferred that the physical property values of the ink be appropriately controlled. Specifically, the surface tension of the ink at 25° C. is preferably 20 mN/m or more to 60 mN/m or less. In addition, the viscosity of the ink at 25° C. is preferably 1.0 mPa's or more to 10.0 mPas or less. The pH of the ink at 25° C. is preferably 7.0 or more to 9.5 or less, more preferably 8.0 or more to 9.5 or less.

### EXAMPLES

The present invention is described in more detail below by way of Examples and Comparative Examples. The present invention is by no means limited to Examples below without departing from the gist of the present invention. “Part(s)” and “%” with regard to the description of the amounts of components are by mass unless otherwise stated.

### <Preparation of Pigment Dispersion Liquid>

### (Pigment Dispersion Liquid 1)

A styrene-acrylic acid copolymer (water-soluble resin) having an acid value of 120 mgKOH/g and a weight-average molecular weight of 10,000 was neutralized with potassium hydroxide whose molar amount was equivalent to the acid value. 10.0 Parts of C.I. Pigment Blue 15:3, 3.0 parts of the neutralized styrene-acrylic acid copolymer (solid content) and 85.0 parts of ion-exchanged water were mixed to provide a mixture. The resultant mixture was dispersed with a sand grinder for 1 hour and then a coarse particle was removed by centrifugation treatment. Further, the supernatant was filtered with a microfilter having a pore size of 3.0 μm (manufactured by FUJIFILM Corporation) under pressure to provide a pigment dispersion liquid 1 in a state in which C.I. Pigment Blue 15:3 was dispersed in the water by the resin. The content of the pigment in the pigment dispersion liquid 1 was 15.0% and the content of the resin (resin dispersant) therein was 4.5%.

(Pigment Dispersion Liquid 2)

A pigment dispersion liquid 2 was obtained by the same procedure as that of the pigment dispersion liquid 1 described above except that C.I. Pigment Red 122 was used instead of C.I. Pigment Blue 15:3. The content of the pigment in the pigment dispersion liquid 2 was 15.0% and the content of the resin (resin dispersant) therein was 4.5%. (Pigment Dispersion Liquid 3)

A pigment dispersion liquid 3 was obtained by the same procedure as that of the pigment dispersion liquid 1 described above except that C.I. Pigment Yellow 74 was used instead of C.I. Pigment Blue 15:3. The content of the pigment in the pigment dispersion liquid 3 was 15.0% and the content of the resin dispersant therein was 4.5%. (Pigment Dispersion Liquid 4)

A commercial pigment dispersion liquid (product name: “CAB-O-JET 250C”, manufactured by Cabot Corporation, pigment content: 15.0%) containing a self-dispersible pigment whose pigment kind was an organic pigment (C.I. Pigment Blue 15:4) was used as a pigment dispersion liquid 4.

(Pigment Dispersion Liquid 5)

A pigment dispersion liquid 5 was obtained by the same procedure as that of the pigment dispersion liquid 1 described above except that an inorganic pigment (carbon black) was used instead of C.I. Pigment Blue 15:3. The content of the pigment in the pigment dispersion liquid 5 was 15.0% and the content of the resin dispersant therein was 4.5%.

(Pigment Dispersion Liquid 6)

A commercial pigment dispersion liquid (product name: “CAB-O-JET 300”, manufactured by Cabot Corporation, pigment content: 15.0%) containing a self-dispersible pigment whose pigment kind was an inorganic pigment (carbon black) was used as a pigment dispersion liquid 6.

### <Preparation of Dye Aqueous Solution>

C.I. Direct Blue 199 was dissolved in water to provide a dye aqueous solution in which the content of C.I. Direct Blue 199 was 15.0%.

### <Preparation of Acrylic Resin>

81.0 Parts of styrene and 19.0 parts of acrylic acid were copolymerized in accordance with an ordinary method to synthesize an acrylic resin (water-soluble resin). A carboxylic acid group in the acrylic resin was neutralized with potassium hydroxide whose molar amount was equivalent to the acid value of the acrylic resin so that the resin was dissolved. After that, an appropriate amount of pure water was added to the solution to provide an aqueous solution of the acrylic resin in which the content of the resin was 20.0%. The acid value of the acrylic resin was 148 mgKOH/g and the weight-average molecular weight of the acrylic resin measured by gel permeation chromatography was 10,000.

### <Preparation of Ink>

Respective components (unit: %) shown in the upper sections of Table 1-1 and Table 1-2 were mixed and sufficiently stirred. After that, the mixtures were filtered with a polypropylene filter having a pore size of 2.5 μm (manufactured by Pall Corporation) under pressure to prepare respective inks. In Table 1-1 and Table 1-2, the term “SURFYNOL 465” represents the product name of an ethylene oxide adduct of acetylene glycol (manufactured by Air Products and Chemicals, Inc., number of moles added of ethylene oxide groups: 10). The clouding point of a 1.0% aqueous solution of the “SURFYNOL 465” was measured to be 55° C.

TABLE 1-1
Compositions and characteristics of inks

| | Ink | | | | | | | | |
|---|---|---|---|---|---|---|---|---|---|
| | 1 | 2 | 3 | 4 | 5 | 6 | 7 | 8 | 9 |
| Pigment dispersion liquid 1 | 26.7 | | | | | 26.7 | 26.7 | 26.7 | 26.7 |
| Pigment dispersion liquid 2 | | 26.7 | | | | | | | |
| Pigment dispersion liquid 3 | | | 26.7 | | | | | | |
| Pigment dispersion liquid 4 | | | | 26.7 | 26.7 | | | | |
| Pigment dispersion liquid 5 | | | | | | | | | |
| Pigment dispersion liquid 6 | | | | | | | | | |
| Dye aqueous solution | | | | | | | | | |
| Aqueous solution of acrylic resin | | | | 6.0 | 2.0 | 6.0 | 10.0 | | |
| Glycerin | 12.0 | 12.0 | 12.0 | 12.0 | 12.0 | 12.0 | 12.0 | 12.0 | 12.0 |
| Triethylene glycol | 7.0 | 10.0 | 10.0 | 10.0 | 10.0 | 10.0 | 10.0 | 10.0 | 7.0 |
| 1,5-Pentanediol | 3.0 | 3.0 | 3.0 | 3.0 | 3.0 | 3.0 | 3.0 | | 3.0 |
| 1,2-Hexanediol | | | | | | | | | |
| 1-(2-Hydroxyethyl)-2-pyrrolidone | | | | | | | | | |
| Triethanolamine | 0.3 | 0.3 | 0.3 | 0.3 | 0.3 | 0.3 | 0.3 | | |
| SURFYNOL 465 | 0.5 | 0.5 | 0.5 | 0.5 | 0.5 | 0.5 | 0.5 | 0.5 | 0.5 |
| Ion-exchanged water | 50.5 | 47.5 | 47.5 | 41.5 | 45.5 | 41.5 | 37.5 | 50.8 | 50.8 |
| Pigment content P (%) | 4.0 | 4.0 | 4.0 | 4.0 | 4.0 | 4.0 | 4.0 | 4.0 | 4.0 |
| Resin content R (%) | 1.2 | 1.2 | 1.2 | 1.2 | 0.4 | 2.4 | 3.2 | 1.2 | 1.2 |
| Value of R/P (times) | 0.3 | 0.3 | 0.3 | 0.3 | 0.1 | 0.6 | 0.8 | 0.3 | 0.3 |

TABLE 1-2
Compositions and characteristics of inks

| | Ink | | | | | | | | |
|---|---|---|---|---|---|---|---|---|---|
| | 10 | 11 | 12 | 13 | 14 | 15 | 16 | 17 | 18 |
| Pigment dispersion liquid 1 | 26.7 | 26.7 | 26.7 | | | | | | |
| Pigment dispersion liquid 2 | | | | | | | | | |
| Pigment dispersion liquid 3 | | | | | | | | | |
| Pigment dispersion liquid 4 | | | | 26.7 | | | | | |
| Pigment dispersion liquid 5 | | | | | | | 26.7 | | |
| Pigment dispersion liquid 6 | | | | | | | | 26.7 | 26.7 |
| Dye aqueous solution | | | | | 26.7 | 26.7 | | | |
| Aqueous solution of acrylic resin | | | | | | 10.0 | | 10.0 | |
| Glycerin | 12.0 | 12.0 | 12.0 | 12.0 | 12.0 | 12.0 | 12.0 | 12.0 | 12.0 |
| T riethylene glycol | 7.0 | 7.0 | 10.0 | 10.0 | 10.0 | 10.0 | 7.0 | 7.0 | 7.0 |
| 1,5-Pentanediol | | | | 3.0 | 3.0 | 3.0 | 3.0 | 3.0 | 3.0 |
| 1,2-Hexanediol | 3.0 | | | | | | | | |
| 1-(2-Hydroxyethyl)-2-pyrrolidone | | 3.0 | | | | | | | |
| Triethanolamine | | | 0.3 | 0.3 | 0.3 | 0.3 | 0.3 | 0.3 | 0.3 |
| SURFYNOL 465 | 0.5 | 0.5 | 0.5 | 0.5 | 0.5 | 0.5 | 0.5 | 0.5 | 0.5 |
| Ion-exchanged water | 50.8 | 50.8 | 50.5 | 47.5 | 47.5 | 37.5 | 50.5 | 40.5 | 50.5 |
| Pigment content P (%) | 4.0 | 4.0 | 4.0 | 4.0 | 0.0 | 0.0 | 4.0 | 4.0 | 4.0 |
| Resin content R (%) | 1.2 | 1.2 | 1.2 | 0.0 | 0.0 | 2.0 | 1.2 | 2.0 | 0.0 |
| Value of R/P (times) | 0.3 | 0.3 | 0.3 | 0.0 | — | — | 0.3 | 0.5 | 0.0 |

### <Configuration of Recording Unit (Ink Cartridge)>

Such a recording unit (ink cartridge) as illustrated in FIG. 3 in which a recording head of such a system as to apply thermal energy to eject an ink was directly attached to the ink storage portion 10 without through intermediation of any heat-radiating plate was prepared. A recording head in which an ejection orifice surface formed from an epoxy resin was subjected to water-repellent treatment with a water repellent was used as the recording head. The water repellent is a resin obtained by curing a condensate of a hydrolyzable silane compound having a fluoroalkyl group (compound having a fluoromethyl group and a methoxy group) and a hydrolyzable silane compound having a cationically polymerizable group (compound having an epoxy group and an ethoxy group). The contact angle of water with the ejection orifice surface subjected to the water-repellent treatment was measured with an automatic contact angle-measuring machine (product name: “CA-W”, manufactured by Kyowa Interface Science Co., Ltd.). As a result, the contact angle was 90° or more. The protective tape 50 is bonded to the ejection orifice surface 30 of the recording head of each of recording units 1 to 4. No protective tape was bonded to a recording unit 5 and its ejection orifice surface was covered with a protective cap capable of covering the surface under a sealed state. The direction (“X→X”, “Y′→Y” or “Y→Y′” in FIG. 3) in which the protective tape 50 is peeled is shown in Table 2. An ejection orifice array in which 384 ejection orifices are arrayed at an array density of 600 dpi is arranged in a recording element substrate for forming the recording head in a Y-Y′ direction. The mass of an ink droplet ejected from one ejection orifice is 5.5 ng.

TABLE 2
Kinds of recording units

| | Pressure-sensitive adhesive for | |
|---|---|---|
| | forming pressure-sensitive adhesion | |
| Recording unit | layer of protective tape | Peeling direction |
| 1 | Silicone-based pressure- | X→X′ |
| | sensitive adhesive | |
| 2 | Acrylic pressure- | X→X′ |
| | sensitive adhesive | |
| 3 | Silicone-based pressure- | Y′→Y |
| | sensitive adhesive | |
| 4 | Silicone-based pressure- | Y→Y′ |
| | sensitive adhesive | |
| 5 | — | — |

### <Evaluation>

### (Ink Jet Recording Apparatus)

An apparatus available under the product name “PIXUS TS5130S” (manufactured by Canon Inc.) was prepared as an ink jet recording apparatus. A blade-shaped wiper made of a urethane resin (thickness: 1.0 mm), which was a wiping unit that wiped an ejection orifice surface, and a recording unit shown in Table 3-1 and Table 3-2 were incorporated into the prepared ink jet recording apparatus. Then, such control that the surface was wiped in the Y→Y′ direction shown in FIG. 3 at a speed of 20 mm/s was performed. In this Example, the recording duty of a solid image recorded under the following condition is defined as 100%: two ink droplets having a mass per droplet of 5.5 ng are applied to a unit region measuring 1/600 inch by 1/600 inch. In the present invention, in evaluation criteria for each of the following items, while ranks “AAA”, “AA”, “A” and “B” were defined as acceptable levels, a rank “C” was defined as an unacceptable level. The evaluation results are shown in Table 3-1 and Table 3-2.

### (Ejection Misdirection)

Each ink shown in Table 3-1 and Table 3-2 was loaded into the ink storage portion of a recording unit shown in Table 3-1 and Table 3-2. To suppress the evaporation of the ink passing through a member for forming the ink storage portion, the resultant recording head was loaded into a polypropylene-made container and a polyethylene terephthalate film was thermally welded to seal the container. The container was loaded into a thermostat at a temperature of 60° C. and a relative humidity of 20%, and was stored for 1 month. It is because the evaluation of ejection misdirection under a more severe condition is required that the recording head was used after the storage. A recovery operation including wiping was performed on the recording head after the storage. At the time of the recovery operation, the ink was warmed to a temperature shown in Table 3-1 and Table 3-2. After that, the nozzle check pattern of the PIXUS TS5130S was recorded and the presence or absence of the occurrence of the ejection misdirection of the ink was observed. When the ejection misdirection occurred, the recovery operation was performed and the nozzle check pattern was recorded again. The recovery operation and the recording of the nozzle check pattern were repeatedly performed until the ejection states of the ink from all the ejection orifices of the recording head became normal. Then, the number of times of the recovery operation required for the ejection states of the ink from all the ejection orifices to become normal was measured, and the ejection misdirection immediately after the start of the initial use of the recording apparatus was evaluated in accordance with the following evaluation criteria.

AAA: The ejection misdirection was prevented from occurring by performing the recovery operation once and no ink adhered to the ejection orifice surface of the recording head.

AA: The ejection misdirection was prevented from occurring by performing the recovery operation once but the ink adhered to the ejection orifice surface.

A: The ejection misdirection was prevented from occurring by performing the recovery operation twice.

B: The ejection misdirection was prevented from occurring by performing the recovery operation three times.

C: The ejection misdirection occurred even after the recovery operation had been performed three times.

### (Image Characteristic)

A solid image measuring 2 cm by 2 cm, the image having a recording duty of 100%, was recorded on each of the following recording mediums 1 and 2 with the above-mentioned ink jet recording apparatus. The recording was performed under the conditions of a temperature of 25°° C. and a relative humidity of 50%. The recorded solid image was placed in an environment at a temperature of 25° C. and a relative humidity of 50% for 1 day. After that, the “water resistance” and “scratch resistance” of the image were each evaluated in accordance with the following procedure, and an image characteristic was evaluated in accordance with the following evaluation criteria.

[Recording Medium]·Recording medium 1: plain paper (product name: “CS-680”, manufactured by Canon Inc.)

·Recording medium 2: glossy paper (product name: “GLOSSY GOLD”, manufactured by Canon Inc.)

### [Image Characteristic]

A: Each of the “water resistance” and the “scratch resistance” was evaluated as “a” or “b”.

C: At least one of the “water resistance” or the “scratch resistance” was evaluated as “c”.

### [Water Resistance]

The recording medium 1 (plain paper) having recorded thereon the solid image was immersed in pure water. After that, the solid image was visually observed and the water resistance of the image was evaluated in accordance with the following evaluation criteria.

a: No smudge of a coloring material was observed.

b: The smudge of the coloring material was observed but was at such a level as to cause no problem.

c: The smudge of the coloring material at such a level as to cause a problem was observed.

### [Scratch Resistance]

Lens-cleaning paper (measuring 3 cm by 3 cm) and a weight (360 g) were mounted on the solid image recorded on the recording medium 2 (glossy paper). The lens-cleaning paper was moved once on the solid image under a state in which the weight was mounted. After that, the state of the solid image was visually observed and the scratch resistance of the image was evaluated in accordance with the following evaluation criteria.

a: No rubbed off of the image was observed.

b: The rubbed off of the image was observed but the ground thereof was not observed.

c: The rubbed off of the image was observed and the ground was observed.

TABLE 3-1
Evaluation conditions and evaluation results

| | | Evaluation conditions | | | |
|---|---|---|---|---|---|
| | | | | Relationship between | Ink |
| | | Recording | | peeling direction and | temperature |
| | | unit | Ink | wiping direction | (° C.) |
| Example | 1 | 1 | 1 | Intersect | 60 |
| | 2 | 1 | 2 | Intersect | 60 |
| | 3 | 1 | 3 | Intersect | 60 |
| | 4 | 1 | 4 | Intersect | 60 |
| | 5 | 1 | 5 | Intersect | 60 |
| | 6 | 1 | 6 | Intersect | 60 |
| | 7 | 1 | 7 | Intersect | 60 |
| | 8 | 1 | 8 | Intersect | 60 |
| | 9 | 1 | 9 | Intersect | 60 |
| | 10 | 1 | 10 | Intersect | 60 |
| | 11 | 1 | 11 | Intersect | 60 |
| | 12 | 1 | 12 | Intersect | 60 |
| | 13 | 2 | 1 | Intersect | 60 |
| | 14 | 3 | 1 | Parallel and | 60 |
| | | | | opposite directions | |
| | 15 | 1 | 1 | Intersect | 55 |
| | 16 | 1 | 1 | Intersect | 40 |
| | 17 | 2 | 8 | Intersect | 40 |
| Comparative | 1 | 4 | 1 | Parallel and | 60 |
| Example | | | | identical direction | |
| | 2 | 4 | 13 | Parallel and | 60 |
| | | | | identical direction | |
| | 3 | 1 | 13 | Intersect | 60 |
| | 4 | 4 | 14 | Parallel and | 60 |
| | | | | identical direction | |
| | 5 | 4 | 15 | Parallel and | 60 |
| Reference | 1 | 5 | 1 | identical direction | 60 |
| Example | 2 | 4 | 16 | Parallel and | 60 |
| | | | | identical direction | |
| | 3 | 1 | 16 | Intersect | 60 |
| | 4 | 4 | 17 | Parallel and | 60 |
| | | | | identical direction | |
| | 5 | 1 | 17 | Intersect | 60 |
| | 6 | 4 | 18 | Parallel and | 60 |
| | | | | identical direction | |
| | 7 | 1 | 18 | Intersect | 60 |

TABLE 3-2
Evaluation conditions and evaluation results

| | | Evaluation results | | | |
|---|---|---|---|---|---|
| | | Ejection | Image | Water | Scratch |
| | | misdirection | characteristic | resistance | resistance |
| Example | 1 | AAA | A | a | b |
| | 2 | AAA | A | a | b |
| | 3 | AAA | A | a | b |
| | 4 | AAA | A | a | b |
| | 5 | AAA | A | a | b |
| | 6 | AAA | A | a | b |
| | 7 | AA | A | a | a |
| | 8 | A | A | a | b |
| | 9 | AA | A | a | b |
| | 10 | AA | A | a | b |
| | 11 | AA | A | a | b |
| | 12 | AA | A | a | b |
| | 13 | AA | A | a | b |
| | 14 | AAA | A | a | b |
| | 15 | AAA | A | a | b |
| | 16 | AA | A | a | b |
| | 17 | B | A | a | b |
| Comparative | 1 | C | A | a | b |
| Example | 2 | AAA | C | b | c |
| | 3 | AAA | C | b | c |
| | 4 | AAA | C | c | a |
| | 5 | AAA | C | c | a |
| Reference | 1 | AAA | A | a | b |
| Example | 2 | AAA | A | a | b |
| | 3 | AAA | A | a | b |
| | 4 | AAA | A | a | b |
| | 5 | AAA | A | a | b |
| | 6 | AAA | C | a | c |
| | 7 | AAA | C | a | c |

Although the evaluation result of the ejection misdirection of each of Example 1 and Example 14 was at the AAA rank, Example 1 was relatively superior to Example 14.

According to the present invention, the ink jet recording method by which an image excellent in water resistance and scratch resistance can be recorded while the occurrence of ejection misdirection immediately after the start of initial use is suppressed can be provided. According to the present invention, the ink jet recording apparatus to be used in the ink jet recording method can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-092622, filed Jun. 5, 2023, and Japanese Patent Application No. 2024-071535, filed Apr. 25, 2024, which are hereby incorporated by reference herein in their entirety.

What is claimed is:

1. An ink jet recording method comprising recording an image with an ink jet recording apparatus comprising:
an aqueous ink comprising an organic pigment and a resin;
an ink storage portion configured to store the aqueous ink;
a recording head incorporated into the ink storage portion, the recording head comprising an ejection orifice surface comprising formed therein an ejection orifice configured to eject the aqueous ink supplied from the ink storage portion; and
a wiping unit configured to wipe the ejection orifice surface,
the recording being performed by applying the aqueous ink ejected from the ejection orifice to a recording medium,
wherein the ejection orifice surface of the recording head has bonded thereto a protective tape comprising an adhesive layer formed from an adhesive, the protective tape being peeled at a time of use thereof, and
wherein a direction in which the protective tape is peeled and a direction in which the ejection orifice surface is wiped with the wiping unit intersect each other or are opposite directions.

2. The ink jet recording method according to claim 1, wherein the resin comprises a water-soluble resin.

3. The ink jet recording method according to claim 1, wherein a content (% by mass) of the organic pigment in the aqueous ink is 0.5% by mass or more to 10.0% by mass or less with respect to a total mass of the ink.

4. The ink jet recording method according to claim 1, wherein a content (% by mass) of the resin in the aqueous ink is 0.1% by mass or more to 20.0% by mass or less with respect to a total mass of the ink.

5. The ink jet recording method according to claim 1, wherein a mass ratio of a content (% by mass) of the resin in the aqueous ink to a content (% by mass) of the organic pigment therein is 0.1 times or more to 0.6 times or less.

6. The ink jet recording method according to claim 1, wherein the aqueous ink further comprises at least one kind of water-soluble organic solvent selected from the group consisting of: a compound having a cyclic amide structure; an alkanediol; and an amine compound.

7. The ink jet recording method according to claim 1, wherein the aqueous ink further comprises at least two kinds of water-soluble organic solvents selected from the group consisting of: a compound having a cyclic amide structure; an alkanediol; and an amine compound.

8. The ink jet recording method according to claim 1, wherein the adhesive is a silicone-based adhesive.

9. The ink jet recording method according to claim 1, wherein the direction in which the protective tape is peeled and the direction in which the ejection orifice surface is wiped with the wiping unit intersect each other.

10. The ink jet recording method according to claim 1, wherein the direction in which the ejection orifice surface is wiped with the wiping unit and a direction in which a plurality of ejection orifice arrays each comprising the plurality of ejection orifices are arrayed in the ejection orifice surface are substantially parallel to each other.

11. The ink jet recording method according to claim 1, wherein the wiping unit is a blade-shaped wiper.

12. The ink jet recording method according to claim 11, wherein a material for forming the wiper is a rubber material formed from a urethane resin.

13. The ink jet recording method according to claim 11, wherein the wiper has a thickness of 0.4 mm or more to 1.1 mm or less.

14. The ink jet recording method according to claim 1, wherein a moving speed of the wiping unit when the ejection orifice surface is wiped with the wiping unit is 15 mm/s or more to 130 mm/s or less.

15. The ink jet recording method according to claim 1,
wherein the recording head comprises a warming unit configured to warm the aqueous ink in the recording head,
wherein the aqueous ink further comprises a surfactant, and
wherein the ink jet recording method further comprises warming the aqueous ink in the recording head to a clouding point of the surfactant or more with the warming unit, followed by wiping of the ejection orifice surface with the wiping unit.

16. An ink jet recording apparatus comprising:
an aqueous ink comprising an organic pigment and a resin;
an ink storage portion configured to store the aqueous ink;
a recording head incorporated into the ink storage portion, the recording head comprising an ejection orifice surface comprising formed therein an ejection orifice configured to eject the aqueous ink supplied from the ink storage portion; and
a wiping unit configured to wipe the ejection orifice surface,
wherein the ejection orifice surface of the recording head has bonded thereto a protective tape comprising an adhesive layer formed from an adhesive, the protective tape being peeled at a time of use thereof, and
wherein a direction in which the protective tape is peeled and a direction in which the ejection orifice surface is wiped with the wiping unit intersect each other or are opposite directions.
